(19) United States
(12) Patent Application Publication
(10) Pub. No.: US 2014/0304779 A1
(43) Pub. Date: Oct. 9, 2014

(54) DESKTOP SHARING SYSTEM AND METHOD

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); SHAN-CHUAN JENG, New Taipei (TW)

(73) Assignee: HON HAI PRECISION INDUSTRY CO., LTD., New Taipei (TW)

(21) Appl. No.: 14/016,157

(22) Filed: Sep. 2, 2013

(30) Foreign Application Priority Data
Apr. 3, 2013 (TW) 102112206

(51) Int. Cl. H04L 29/06

(52) U.S. Cl. CPC H04L 63/10
USPC 726/4

(57) ABSTRACT

A server remotely share files in a desktop to one or more clients. The server assigns a meeting desktop to a client according to the assignment request, and receives login requests from other clients for logging in the meeting desktop. The server authorizes a control privilege to a shared client that needs to share files. The server receives the files from the shared client. Then the server opens and shares the files in the meeting desktop to share with all clients in the meeting desktop.

### BACKGROUND

1. Technical Field

Embodiments of the present disclosure relate to desktop sharing technology, and particularly to a system and method for remotely share files on a desktop.

2. Description of Related Art

Online meeting technology allows people located in different location to meet and share information over the Internet or over a private network. To accomplish this, a desktop is often shared by users in different remote locations. This allows the meeting attendees at the remote locations to share files on the same desktop. At present, the desktop sharing often directly occurs among one or more clients. For example, one client can directly share its desktop with other clients. Additionally, if the desktop of a client is shared by the one or more other clients, this client is regarded as a center client. This requires the center client to have a sufficiently large network bandwidth or other clients connecting to its desktop may be disconnected. Thus, there is room for improvement in the art.

### BRIEF DESCRIPTION OF THE DRAWINGS

FIG. 1 is a schematic block diagram of one embodiment of a desktop sharing system.

FIG. 2 is a block diagram of one embodiment of function modules of a server included in FIG. 1.

FIG. 3 is a flowchart of one embodiment of a desktop sharing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

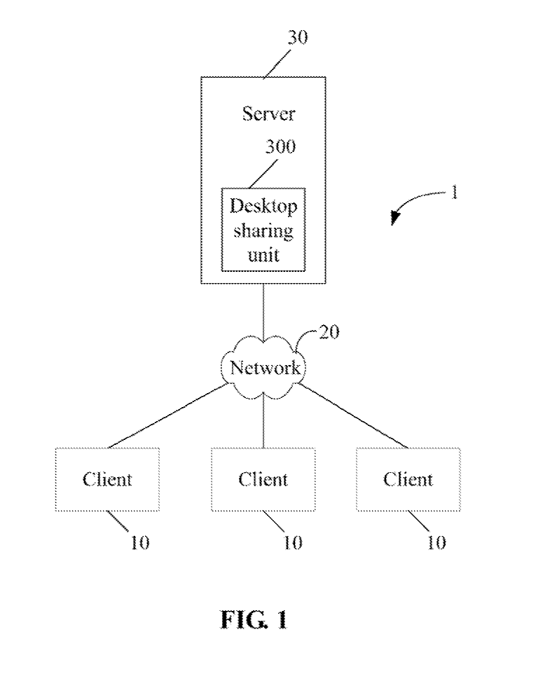

FIG. 1 is a system view of one embodiment of a desktop sharing system 1. In one embodiment, the desktop sharing system 1 may include one or more clients 10, a network 20 and a server 30. The server 30 is connected to the one or more clients 10 via the network 20. The network 20 may be, but is not limited to, a wide area network (e.g., the Internet) or a local area network. The desktop sharing system 1 shares a desktop of one client 10 with other clients 10. The server 30 is also connected to a database system using a data connectivity, such as open database connectivity (ODBC) or JAVA database connectivity (JDBC), for example. Additionally, each client 10 provides a login interface, which is displayed on a display device of the client 10. For example, the user may input an ID and a password using an input device (e.g., a keyboard) in the login interface, and operates the client 10.

The server 30, in one example, may be a dynamic host configuration protocol (DHCP) server, which provides a DHCP service. In one embodiment, the server 30 assigns Internet protocol (IP) addresses to the clients 10 using the DHCP service. In one embodiment, the server 30 uses dynamic allocation to assign the IP addresses to the clients 10. For example, when the server 30 receives a request from a client 10 via the network 20, the server 30 dynamically assigns an IP address to the clients 10. In one embodiment, the server 30 may be a personal computer (PC), a network server, or any other data-processing equipment which can provide IP address allocation function.

The server 30 also includes a meeting desktop pool, which includes one or more meeting desktops. Each meeting desktop is integrated with a virtual network computing (VNC) viewer. The meeting desktop is a graphical desktop sharing application that uses a remote frame buffer protocol (RFB) to remotely share a desktop to one or more clients 10. For example, if three clients 10 log in the meeting desktop, the three clients share a same desktop via the meeting desktop. The meeting desktop is a cross-platform application that can run on different operating systems.

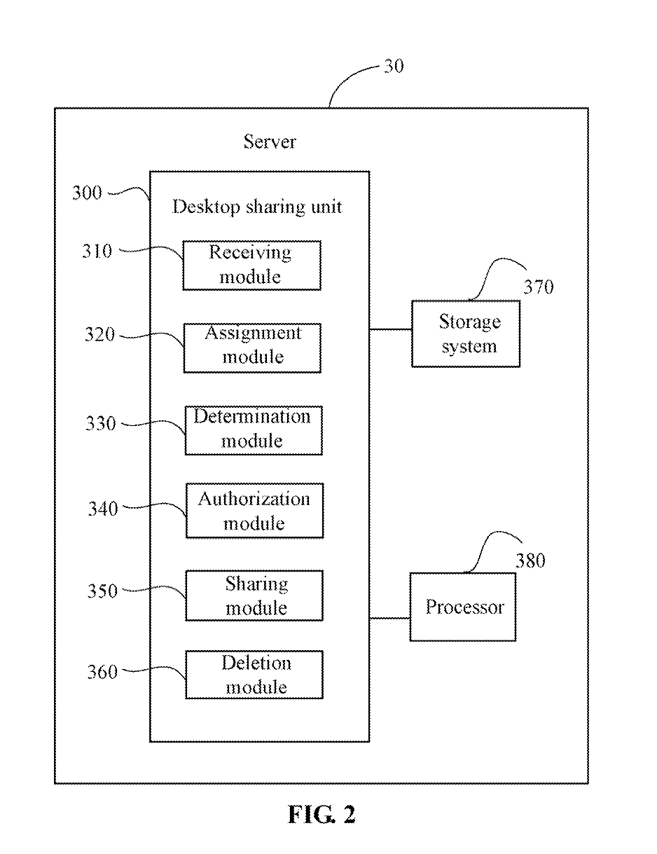

FIG. 2 is a block diagram of one embodiment of function modules of the server 30. The server 30 includes a desktop sharing unit 300, a storage system 370, and at least one processor 380. In one embodiment, the desktop sharing unit 300 includes a receiving module 310, an assignment module 320, a determination module 330, an authorization module 340, a sharing module 350 and a deletion module 360. The modules included in the desktop sharing unit 300 may include computerized code in the form of one or more programs that are stored in the storage system 370. The computerized code includes instructions that are executed by the at least one processor 380 to provide functions for the modules 310-360. The storage system 370 may be a memory, such as an EPROM, hard disk drive (HDD), or flash memory.

The receiving module 310 receives an assignment request from a client 10.

In one embodiment, the assignment request is used to apply for a meeting desktop in the meeting desktop pool.

The assignment module 320 assigns a meeting desktop to the client 10 according to the assignment request. In one embodiment, if the assignment request includes a name of the meeting desktop, the client 10 is assigned with the meeting desktop with that name. For example, if the client 10 sends the assignment request to the server 30, and the assignment request includes the name “001,” which is the name of the meeting desktop, the meeting desktop 001 is assigned to the client 10. If the assignment request does not include any name of the meeting desktop, the assignment module 320 randomly selects one meeting desktop from the meeting desktop pool, and assigns the selected meeting desktop to the client 10. Additionally, the name of the meeting desktop can be changed after the meeting desktop is assigned to the client 10. For example, if the meeting desktop 001 is assigned to the client 10, and the client 10 may change the name of the meeting desktop to “Client 10 meeting room.”

The receiving module 310 further receives login requests from other clients for logging into the meeting desktop. In one embodiment, the login request is used to request logging into the meeting desktop. The login request includes the name of the meeting desktop. The login request may be approved by the client 10 that is controlling the meeting desktop.

The determination module 330 determines if any client 10 logged in the meeting desktop needs to share a desktop. In one embodiment, if one client 10 logged in the meeting desktop needs to share desktop with other clients, the client 10 sends a sharing request to the meeting desktop and notify the meeting desktop that the client 10 needs to share the desktop with other clients. The client 10 needs to share desktop upon the condition that the meeting desktop receive a sharing request from the client 10. In one embodiment, the client 10 is regarded as a shared client 10 when the client 10 needs to share the desktop.

The authorization module 340 authorizes a control privilege to the shared client 10, in response to a determination that the shared client 10 needs to share the desktop. In one embodiment, if the shared client 10 is authorized to have the control privilege, the shared client 10 can control the meeting desktop, for example, the shared client 10 can share the desktop with other clients, upload the files into the meeting desktop, delete the files from the meeting desktop, or invite other clients 10 to login the meeting desktop.

The sharing module 350 shares the desktop of the shared client 10 having control privilege to all clients in the meeting desktop. In one embodiment, the desktop of the client 10 having the control privilege are shared to all clients logging in the meeting desktop via the VNC viewer.

The receiving module 310 receives the files from the shared client 10 having the control privilege, and opens the files in the meeting desktop and shares the opened files to all clients 10 logging in the meeting desktop. In one embodiment, the files are remotely opened by the client 10 having the control privilege, and are shared to all clients logging in the meeting desktop via the VNC viewer.

The deletion module 360 deletes the files from the meeting desktop when all clients exit from the meeting desktop. In one embodiment, if the meeting desktop does not include any clients, the deletion module 360 deletes the files from the meeting desktop.

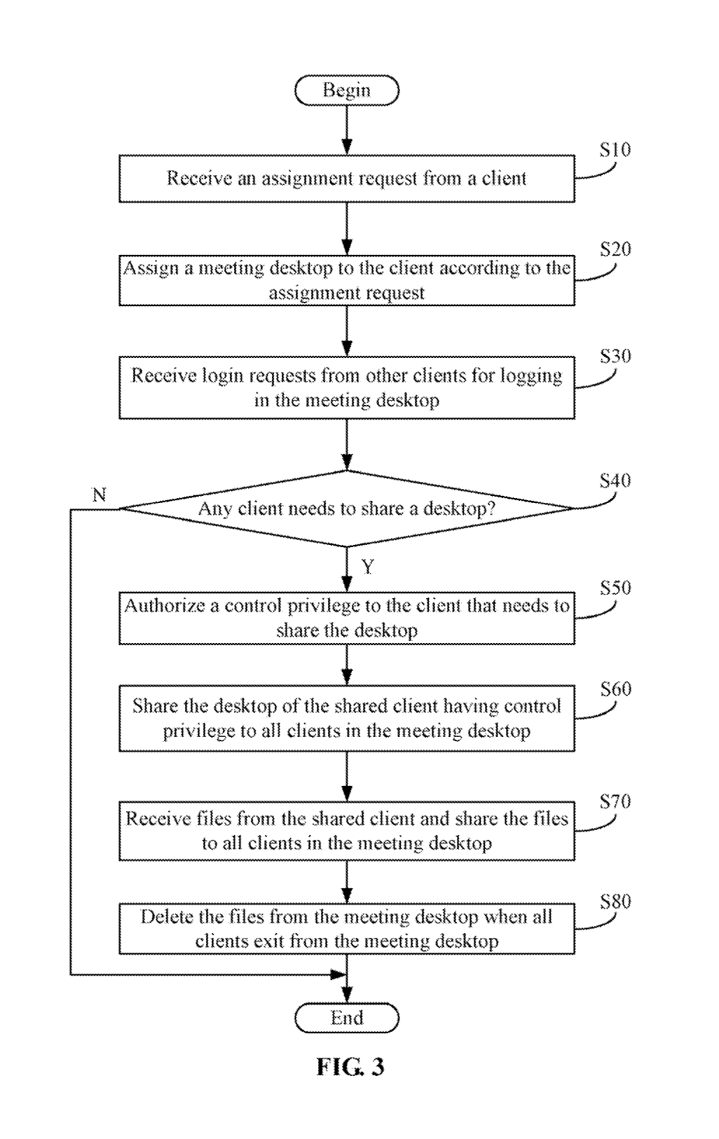

FIG. 3 is a flowchart of one embodiment of a desktop sharing method. Depending on the embodiment, additional steps may be added, others deleted, and the ordering of the steps may be changed.

In step S10, the receiving module 310 receives an assignment request from a client 10. In one embodiment, the client 10 sends the assignment request to the server 30 and applies for one meeting desktop from the meeting desktop pool. Additionally, the client 10 can request a specific meeting desktop by integrating the name of the specific meeting desktop into the assignment request.

In step S20, the assignment module 320 assigns a meeting desktop to the client 10 according to the assignment request. In one embodiment, if the assignment request includes a name of the specific meeting desktop, the specific meeting desktop is assigned to the client 10. For example, if a client 10 sends the assignment request to the server 30, and the assignment request includes the name “001,” which is the name of the meeting desktop, the meeting desktop 001 is assigned to the client 10. Furthermore, if the assignment request is not integrated with any name of the meeting desktop, one meeting desktop is randomly selected from the meeting desktop pool, and assigned to the client 10.

In step S30, the receiving module 310 further receives login requests from other clients for logging in the meeting desktop. In one embodiment, the logged client 10 that is authorized to control the meeting desktop can approve or deny new client's requests to log in the same meeting desktop.

In step S40, the determination module 330 determines if any client 10 logged in the meeting desktop needs to share a desktop. In one embodiment, if a client 10 logged in the meeting desktop needs to share the desktop with other clients, the client 10 is regarded as a shared client 10, the procedure goes to step S50. If no client 10 logged in the meeting desktop needs to share the desktop, the procedure ends.

In step S50, the authorization module 340 authorizes a control privilege to the shared client 10. In one embodiment, once the shared client 10 has the control privilege, the shared client 10 can control the meeting desktop. In other words, the shared client 10 having the control privilege can share the desktop with other client, upload and delete files in the meeting desktop. It can also invite other clients to join in the meeting desktop. The shared client 10 can also approve other clients log in the meeting desktop. The files may be, but are not limited to, a WORD file, a PDF file, a PPT file, a EXCEL file, a TXT file, an extensible markup language (XML) file or a hypertext markup language (HTML) file.

In step S60, the sharing module 350 shares the desktop of the shared client 10 having control privilege to all clients in the meeting desktop.

In step S70, the receiving module 310 receives the files from the shared client 10 having the control privilege and uploads the files into the meeting desktop, and opens the files in the meeting desktop and shares the opened files to all clients in the meeting desktop. In one embodiment, the files are remotely opened by the shared client 10 having the control privilege, and are shared to all clients in the meeting desktop via the VNC viewer. All clients logging in the meeting desktop can view the opened files in the same desktop.

In step S80, the deletion module 360 deletes the files from the meeting desktop when all clients exit from the meeting desktop.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A server comprising:
at least one processor;
a meeting desktop pool comprising one or more meeting desktop; and
a storage system that stores one or more programs, when executed by the at least one processor, cause the at least one processor to perform a desktop sharing method, the method comprising:
receiving an assignment request from a client;
assigning a meeting desktop to the client according to the assignment request;
receiving login requests from other clients for logging in the meeting desktop;
authorizing a control privilege to a shared client, in response to a determination that the shared client needs to share a desktop with other clients; and
sharing the desktop of the shared client having control privilege to all clients in the meeting desktop.

2. The server of claim 1, wherein the method further comprises:
receiving the files from the shared client having the control privilege;
opening the files in the meeting desktop and sharing the opened files with all clients in the meeting desktop; and
deleting the files from the meeting desktop when all clients exit from the meeting desktop.

3. The server of claim 1, wherein the meeting desktop is assigned to the client according to a name of the meeting desktop when the assignment request comprises the name of the meeting desktop.

4. The server of claim 1, wherein the meeting desktop is randomly selected from the meeting desktop pool, and assigned to the client when the assignment request does not comprises the name of the meeting desktop.

5. The server of claim 1, wherein the shared client can control the meeting desktop when the shared client is authorized to have the control privilege.

6. A computer-based installation method being performed by execution of computer readable program code by a processor of a server, the server comprising one or more meeting desktops, the server in communication with one or more clients, the method comprising:
receiving an assignment request from a client;
assigning a meeting desktop to the client according to the assignment request;
receiving login requests from other clients for logging in the meeting desktop;
authorizing a control privilege to a shared client, in response to a determination that the shared client needs to share a desktop with other clients; and
sharing the desktop of the shared client having control privilege to all clients in the meeting desktop.

7. The method of claim 6, wherein the method further comprising:
receiving the files from the shared client having the control privilege;
opening the files in the meeting desktop and sharing the opened files with all clients in the meeting desktop; and
deleting the files from the meeting desktop when all clients exit from the meeting desktop.

8. The method of claim 6, wherein the meeting desktop is assigned to the client according to a name of the meeting desktop when the assignment request comprises the name of the meeting desktop.

9. The method of claim 6, wherein the meeting desktop is randomly selected from the meeting desktop pool, and assigned to the client when the assignment request does not comprises the name of the meeting desktop.

10. The method of claim 6, wherein the shared client can control the meeting desktop when the shared client is authorized to have the control privilege.

11. A non-transitory computer-readable medium having stored thereon instructions that, when executed by a server, the server comprising one or more meeting desktops, the server in communication with one or more clients, causing the server to perform a desktop sharing method, the method comprising:
receiving an assignment request from a client;
assigning a meeting desktop to the client according to the assignment request;
receiving login requests from other clients for logging in the meeting desktop;
authorizing a control privilege to a shared client, in response to a determination that the shared client needs to share a desktop with other clients; and
sharing the desktop of the shared client having control privilege to all clients in the meeting desktop.

12. The non-transitory medium of claim 11, wherein the method further comprising:
receiving the files from the shared client having the control privilege;
opening the files in the meeting desktop and sharing the opened files with all clients in the meeting desktop; and
deleting the files from the meeting desktop when all clients exit from the meeting desktop.

13. The non-transitory medium of claim 11, wherein the meeting desktop is assigned to the client according to a name of the meeting desktop when the assignment request comprises the name of the meeting desktop.

14. The non-transitory medium of claim 11, wherein the meeting desktop is randomly selected from the meeting desktop pool, and assigned to the client when the assignment request does not comprises the name of the meeting desktop.

15. The non-transitory medium of claim 11, wherein the shared client can control the meeting desktop when the shared client is authorized to have the control privilege.
